(19) United States
(12) Patent Application Publication
(10) Pub. No.: US 2026/0215633 A1
(43) Pub. Date: Jul. 30, 2026

(54) Toilet Seat Scale

(71) Applicant: Nino Martinez, Santa Monica, CA (US)

(72) Inventor: Nino Martinez, Santa Monica, CA (US)

(21) Appl. No.: 19/041,834

(22) Filed: Jan. 30, 2025

(51) Int. Cl. A47K 13/24; G01G 19/44; G01G 19/52

(52) U.S. Cl. CPC A47K 13/24; G01G 19/44; G01G 19/52

(57) ABSTRACT

A weight tracking system adapted to be installed on a toilet. The toilet seat has a first weight sensor installed between a toilet seat and a toilet bowl for determining a first weight measurement when a user sits upon the toilet seat. A foot scale is positioned in front of the toilet bowl, the foot scale having a second weight sensor for determining a second weight measurement when the user sits upon the toilet seat and rests his feat upon the foot scale. The combined first and second weight measurements are summed to determine the user's total weight.

### BACKGROUND OF THE INVENTION

### Field Of The Invention

This invention relates generally to health monitoring devices, and more particularly to a scale integrated into a toilet for automatic daily weight monitoring.

### Description Of Related Art

Modern consumers expect seamless integration of technology into everyday life, driving demand for products that offer convenience and enhanced functionality. As health monitoring devices become more integrated into daily routines, the market sees a shift toward products that combine health data management with common household fixtures. Innovations in smart home technologies are raising the standard for what consumers expect, pushing companies to innovate continuously. Furthermore, rising health awareness and participation in wellness activities are expanding the market for health monitoring devices.

Most standalone health monitoring devices disrupt daily routines by requiring a separate set of tasks and routines to operate. There is a need in the field for a health monitoring device that does not disrupt daily routines, appealing to users who value convenience and simplicity.

Traditional scales, while functional, require deliberate effort and conscious use, often leading to sporadic monitoring that lacks the consistency required for meaningful health management.

Wang, U.S. Pat. No. 10,729,411 teaches a smart toilet capable of monitoring excrement and urine. The toilet includes a toilet bowl, a toilet seat, a telescopic lifting device, an excrement sample collection device, an excrement specimen preprocessing device, an excrement sample detection and analysis device, a telescopic lighting and photographing device, and a smart terminal. The whole process of bowel movement can be monitored to observe the general characteristics of the excrement and the presence or absence of parasites or eggs and to weigh the excrement, thereby realizing the automatic collection of an excrement sample and the pretreatment of the excrement specimen to provide convenience for the hospital users. Wang also holds DE patent no. 112015006935.

Clements, U.S. Pat. No. 9,756,297 teaches a toilet having a cameras connected thereto to capture images of the user's body, posterior, and back. The camera's view of the user is shown on a display and allows a user to view difficult to view areas of their body while they are sitting on the toilet. A computer visually diagnoses the areas for possible health concerns. Health sensors can also be used to perform health tests, wherein heath test data is displayed, and can be sent to health providers over the internet for further diagnosis.

Borkholder, U.S. Pat. No. 2022/0218286 teaches an apparatus, system and method for medical analysis of a seated individual. Borkholder is primarily directed toward analyzing the aortic valve opening, the PTT, and the PWV, but may include a mechanism for calculating certain weight measurements.

Hall, U.S. Pat. No. 10,888,278 teaches a method of obtaining health data of a toilet user using one or more sensors. In particular, dynamic heart stress readings over time to obtain rolling averages of heart function and heart health, and deviations from the rolling averages may trigger notifications. Other health related measurements and functions such as temperature, respirations, heart rate, electrocardiogram, echocardiogram, and stethoscope sounds are also recorded and stored for trending and data analysis.

Hall also holds U.S. Pat. No. 9,595,185, which teaches a toilet apparatus for providing automatic user identification. The automatic identification uses a combination of an instrumented toilet seat and an instrumented foot scale to provide user specific identification data. User health trends may be saved and reported based on the automatic user identification. User identification also allows preconfigured toilet control settings to be loaded into memory upon user identification.

While many prior art toilet devices are directed toward analysis of excrement, the present invention considers non-invasive health-monitoring technologies that do not directly interact with bodily waste. The present invention fulfills these needs and provides further advantages as described in the following summary.

### SUMMARY OF THE INVENTION

The present invention teaches certain benefits in construction and use which give rise to the objectives described below.

The present invention provides a weight tracking system adapted to be installed on a toilet. The toilet seat has a first weight sensor installed between a toilet seat and a toilet bowl for determining a first weight measurement when a user sits upon the toilet seat. A foot scale is positioned in front of the toilet bowl, the foot scale having a second weight sensor for determining a second weight measurement when the user sits upon the toilet seat and rests his feat upon the foot scale. The combined first and second weight measurements are summed to determine the user's total weight.

A primary objective of the present invention is to provide a weight tracking system having advantages not taught by the prior art.

Another objective is to provide a weight tracking system that may be installed on an existing toilet, or alternatively may be manufactured to be an integral part of a toilet.

A further objective is to provide a weight tracking system that allows a user to track weight over time, automatically, without the need for the user to remember to do intentional weigh-ins.

A further objective is to provide a weight tracking system that is able to track multiple users, and automatically determine the user associated with a given weight.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention.

FIG. 1 is a block diagram of a weight tracking system according to one embodiment of the present invention;

FIG. 2 is a perspective view of a toilet apparatus of the system, shown being used in conjunction with a smart phone; and

FIG. 3 is a perspective view of a second embodiment thereof.

### DETAILED DESCRIPTION OF THE INVENTION

The above-described drawing figures illustrate the invention, a toilet seat scale for automatic weight monitoring.

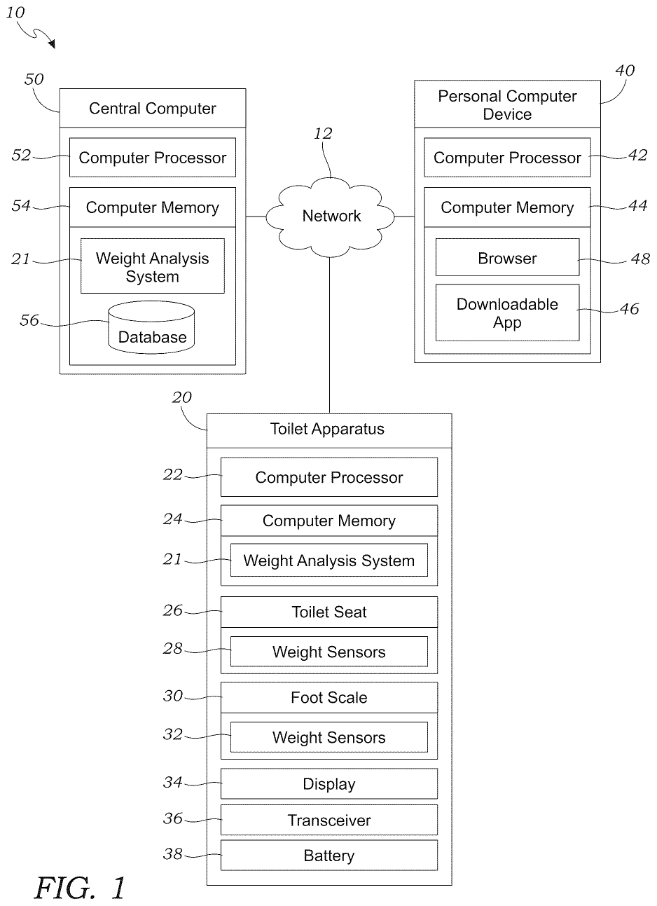

FIG. 1 is a block diagram of a weight tracking system 10 according to one embodiment of the present invention. As shown in FIG. 1, in this embodiment the weight tracking system 10 may be used with a toilet apparatus 20, and may further function in coordination with a personal computer device 40. The system 10 may also be operably coordinated from and controlled by a central computer 50 for running a weight analysis system 21, as discussed in greater detail below. The present invention is directed toward combining a high-precision weight scale with a toilet seat 46 to enhance daily health monitoring without altering user habits.

As shown in FIG. 1, the toilet apparatus 20 may include a computer processor 22 and a computer memory 24, the computer memory 24 storing executable code in the form of the weight analysis system 21. Alternatively, the computer processing aspects of the invention may be performed by a separate computer system, such as a smart phone, tablet, or other computer device, using a downloaded app.

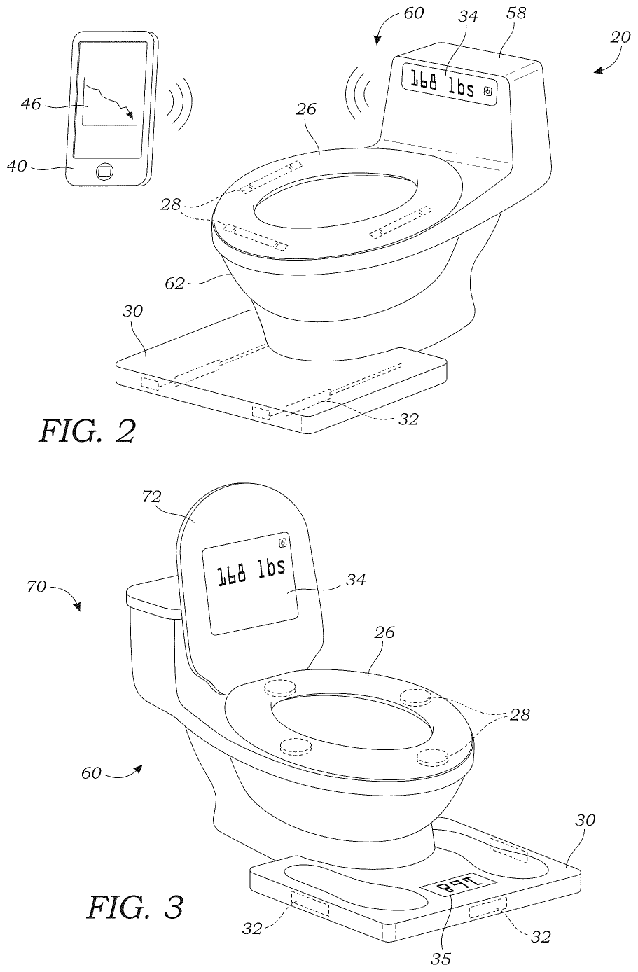

The toilet apparatus 20 further includes the toilet seat 46 having weight sensors 28, and a foot scale 30 having weight sensors 32, discussed in greater detail below. The toilet apparatus 20 may further comprise a display 34 such as a display screen, a transceiver 36 for communicating with the personal computer device 40 and the central computer 50, and a battery 38 for powering the toilet apparatus 20. Embodiments of the toilet apparatus 20 are shown in FIGS. 2-3 and discussed in greater detail below.

In this embodiment, the personal computer device 40 comprises a computer processor 42 and a computer memory 44, the computer memory 44 storing executable code which may be in the form of the downloadable application 46 (“app”), a browser 48 (in conjunction with an associated website), or any other configuration known in the art. As shown in FIG. 1, all of the computer devices of the system may communicate with each other via one or more networks 12. In this case the personal computer device 40 communicates with the toilet apparatus 20 (e.g., via Bluetooth® or equivalent network known in the art, and each communicate via some form or larger network, such as the Internet, cellular networks, WIFI, and/or combination, as discussed in greater detail below.) In some embodiments, the personal computer device 40 is in the form of a smart phone, but in other embodiments, it may be in the form of a tablet, desktop or laptop computer, smart watch, smart television, generic electronic processing and/or displaying unit, cloud storage or remote data repository, etc., or any other type of device capable of the essential functions described. Since this type of device is well-known in the art, it is not described in further detail herein.

As illustrated, the central computer 50 comprises a computer processor 52, a computer memory 54, and a database 56, wherein the computer memory 54 stores executable code that, when executed, enables the system to perform the processes described below. In this embodiment, the executable code includes the weight analysis system 21. The central computer 50 may communicate with the personal computer device 40 and the toilet apparatus 20 via the network 12.

For purposes of this application, the terms “computer,” “computer device,” “server,”and similar terms, refer to a device and/or system of devices that include at least one computer processor, and some form of computer memory having a capability to store data. The computer may comprise hardware, software, and firmware for receiving, storing, and/or processing data as described below. For example, a computer may comprise any of a wide range of digital electronic devices, including, but not limited to, a server, a desktop computer, a laptop, a smart phone, a tablet, or any form of electronic device capable of functioning as described herein.

The term “computer processor” as used herein refers to an electrical component that performs operations on an external data source, such as a computer memory, typically in the form of a microprocessor, although any equivalent structure may be used.

The term “computer memory” as used herein refers to any tangible, non-transitory storage that participates in providing instructions to a processor for execution. Such a medium may take many forms, including but not limited to, non-volatile media, volatile media, and any equivalent media known in the art. Non-volatile media includes, for example, ROM, magnetic media, and optical storage media. Volatile media includes, for example, DRAM, which typically serves as main memory. Common forms of computer memory include, for example, hard drives and other forms of magnetic media, optical media such as CD-ROM disks, as well as various forms of RAM, ROM, PROM, EPROM, FLASH-EPROM, solid state media such as memory cards, and any other form of memory chip or cartridge, or any other medium from which a computer can read. While several examples are provided above, these examples are not meant to be limiting, but illustrative of several common examples, and any similar or equivalent devices or systems may be used that are known to those skilled in the art.

The term “database” as used herein, refers to any form of one or more (or combination of) relational databases, object-oriented databases, hierarchical databases, network databases, non-relational (e.g. NoSQL) databases, document store databases, in-memory databases, programs, tables, files, lists, or any form of programming structure or structures that function to store data as described herein.

The network 12 may include any device or system for communicating information from one computer device to another. For example, a global computer network (e.g., the Internet) may be used, including any form of local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs, enabling messages to be sent from one to another. In addition, communication links within LANs typically include twisted wire pair or coaxial cable, while communication links between networks may utilize analog telephone lines, full or fractional dedicated digital lines, Digital Subscriber Lines (DSLs), wireless links including satellite links, or other communications links known to those skilled in the art. The network may further include any form of wireless network, including cellular systems, WLAN, Wireless Router (WR) mesh, or the like. Access technologies such as 3G, 4G, 5G, and future access networks may enable wide area coverage for mobile devices. In essence, the wireless network may include any wireless communication mechanism known in the art by which information may travel between computers of the present system.

The computer may function to perform the following steps. First, upon determining the weight of the user, the system 10 is able to determine the identity of the user. This may be achieved by selecting the user with the closest weight; or alternatively, it may incorporate artificial intelligence to track weight data over time, so that the system is able to determine the identity of the user, even when there are many people who may be close in weight. Furthermore, the system 10 may enable or require the user to enter (or confirm) his or her identity.

The weight measurements are then stored, associated with the identity of the user. This enables the user to review data collected over time, to track health issues. This data may also be tracked by family members, caretakers, doctors, and/or any other responsible people or systems, to alert the appropriate people if a user is not meeting weight goals (or who has achieved success in reaching weight targets).

FIG. 2 is a perspective view of the toilet apparatus 20, shown being used in conjunction with the smart phone 40 having the weight analysis system 21. As shown in FIG. 2, in this embodiment, the toilet apparatus 20 comprises the toilet seat 46 and the foot scale 30 that are adapted to be installed on a toilet 60 having a tank 58 and a toilet bowl 62. In some uses, the toilet 60 is constructed specifically for use with the weight tracking system 10, but in other embodiments, the toilet seat 46, foot scale 30, and display 34 may be installed on any existing toilet. The toilet apparatus 20 may be provided with universal mounting solutions so that it is compatible with different toilet designs.

In this embodiment, the weight sensors 28 may be in the form of a first load cell, which may include and a first plurality of strain sensors for determining a first weight measurement when a user sits upon the toilet seat 46. The weight sensors 28 are positioned between a toilet seat 46 and a toilet bowl. In some embodiments, the first plurality of strain sensors includes at least one strain gauge sensor on the bottom side of the toilet seat 46.

The foot scale 30 is positioned in front of the toilet bowl 62 and has the weight sensors 32 in the form of a second load cell and a second plurality of strain sensors for determining a second weight measurement when the user sits upon the toilet seat 46. The second plurality of strain sensors may also include at least one strain gauge sensor beneath an upper surface of the foot scale 30.

The combined first and second weight measurements may be displayed on the digital display 34 of the toilet apparatus 20. In other embodiments, the digital display 34 may display only the first weight measurement, or only the second weight measurement. When a user sits on the toilet seat 46, the user's weight may be detected by one or more pressure transducers fixed to the toilet seat 46 and by one or more pressure transducers fixed to the foot scale 30. The pressure transducers may be strain gauge weight measurement sensors, or other well-known pressure transducer sensors such as resistive weight sensors, capacitive weight sensors, inductive weight sensors, piezoelectric weight sensors, etc. Weight measurements may also be taken continuously, forming a weight signature with respect to time, while a user is using a toilet. For example, while a user is using the toilet his or her weight may change from one side of the seat to the other or may shift from the toilet seat 46 to the toilet foot scale 30. A weight signature may indicate average times of toilet use, total weight at the toilet seat 26, total weight at the toilet foot scale 30, and movement weight pattern distributions with respect to time at both the toilet seat 46 and the toilet foot scale 30. A total weight may also be able to determine whether a user is standing or sitting based on a detected weight on the toilet seat 46 and the toilet foot scale 30.

Weight ratio may include a weight ratio pattern between multiple pressure transducer weight sensors on the toilet seat 46. Weight ratio may include a weight ratio pattern between multiple pressure transducer weight sensors on the toilet foot scale 30. For example, side-to-side and front-to-back and side-to-back weight ratios may be used to create user signatures for both the toilet seat 46 and for the foot scale 30. A combination of ratios between the toilet seat 46 and the foot scale 30 may also be used to form user identification signatures. A front to back weight ratio may be able to determine if a user is facing forward or backwards while standing on the foot scale 30.

The first and second load cells 28 and 32 are adapted to communicate with the weight analysis system 21 via the computer processor 22 of the toilet apparatus 20, so that the combined first and second weight measurements may be displayed on the digital display 34, and transmitted to the personal computer device 40 and the central computer 50 via the transceiver 36 and the network 12. In some embodiments the transceiver 36 is in the form of a wireless transmittal device adapted to enable wireless (e.g., Bluetooth, WiFi) connectivity, for ease of connection with downloadable app 46 of the smart phone 40.

In use, the weight analysis system 21 collects weight measurements of the user via the load cells and pluralities of strain sensors, and analyzes the weight measurements using the weight analysis system 21 to determine weight changes over time. The toilet apparatus 20 may communicate with the database 56 of the central computer 50 to determine a history of weight measurements, which may be associated with a user identification, i.e., from a specific smart phone, average weight, or other means of identification. For example, a camera or other form of sensor may be included for identification, or the user may select his or her identity on the digital display 34/personal computer device 40, or other means. The digital display 34 may be in the form of a touch screen, or it may include buttons or equivalent mechanism on/adjacent the screen, or alternatively the toilet apparatus 20 may be operated entirely from the personal computer device 40.

In various embodiments, all the components of the toilet apparatus 20 may be waterproof, so that internal electronics are not exposed to water from the plumbing of the toilet, adjacent shower/sink, etc. The battery 38 may be wireless to prevent unwanted wiring from being exposed to potential exterior moisture, but the battery 38 may alternatively be powered via a wired connection. Similarly, the foot scale 30 may include a separate computer processor, computer memory, and transceiver (not shown), for wireless communication with the rest of the toilet apparatus 20 and smart phone 40, or it may be directly connected to the rest of the toilet apparatus 20, wherein wireless communication comes from the toilet seat 46, or elsewhere.

In some embodiments, the downloadable app 46/website may include various elements for tracking weight and displaying weight. As shown in FIG. 2, the user may be provided with a graph to show changes over time, or other form of visual representation of weight changes. The downloadable app 46/website may include other features typically associated with health tracking systems, including account management, settings, support options, social linking, or other features. In particular, the user may be able to communicate with a medical practitioner to share the tracked weight, ask questions, or report other biometric data, taken from added sensors on the toilet, manually input, or taken from other devices/sensors. The user may be able to set goal weights and/or retrieve a history of weigh-ins from the database 56. The app 46 may send reminders to the user to connect to the toilet apparatus 20.

In the embodiment of FIG. 2, the digital display 34 is mounted on the tank 58 of the toilet, such as in the case of a lidless toilet seat, but the digital display 34 may be positioned anywhere on the toilet and/or toilet apparatus 20, one example being shown in FIG. 3 and discussed below.

FIG. 3 is a perspective view of a second embodiment of the toilet apparatus 70. As shown in FIG. 3, in this embodiment, the toilet seat 46 includes a lid 72 having the display 34 on the underside. As discussed above, the display 34 may alternatively be on the top of the lid 72, or on the side of the tank 58, bowl 62, etc., or it even may be mounted outside of the toilet 60, e.g., on a wall, stand, etc. In this embodiment, an additional display 35 is located on the foot scale 30.

As shown in FIGS. 2-3, different types of weight sensors (strain gauges/load cells/pressure transducers) may be implemented into the toilet apparatus 20/70. FIG. 2 illustrates a generally rectangular strain gauge having a fixed end and a free end. FIG. 3 illustrates “pancake” load cells distributed across the bottom surface of the toilet seat 46. Any form of weight sensor may be included in the weight tracking system 10, and should be considered within the scope of the present invention.

In use, the weight tracking system 10 may be ideal for consumer home use, particularly for health-conscious individuals seeking a convenient and unobtrusive way to track weight, seamlessly fitting into daily routines without extra effort. Other individuals who may benefit include elderly users and those with physical disabilities who face challenges using traditional scales. The scale's integration into a toilet seat 46 makes it accessible for individuals with limited mobility, ensuring safety and ease of use.

In other applications, the weight analysis system 21 may be used in healthcare facilities such as hospitals, clinics, assisted living facilities, or any other facility that requires regular and accurate patient monitoring. The weight analysis system 21 provides a hands-free, hygienic way to monitor patient weight, crucial for medication dosing and health record accuracy. Regular weight monitoring is vital for patient care, especially for those with heart disease, kidney failure, or other conditions where fluid balance is critical. The weight analysis system 21 allows for non-intrusive, continuous monitoring. In pediatrics, monitoring the weight of young children can be challenging. The present invention offers a stress-free method for obtaining accurate weight measurements in pediatric clinics or at home.

In further applications, the weight analysis system 21 may be integrated into athletic training facilities or facilities of companies with wellness programs for their staff. It may also be integrated into academic and commercial research institutions looking for tools in long-term health studies. The scale can provide continuous, automated data collection, offering a valuable resource for athletic training, employee health initiatives, and health and medical research.

The title of the present application, and the claims presented, do not limit what may be claimed in the future, based upon and supported by the present application. Furthermore, any features shown in any of the drawings may be combined with any features from any other drawings to form an invention which may be claimed.

As used in this application, the words “a,” “an,” and “one” are defined to include one or more of the referenced item unless specifically stated otherwise. The terms “approximately” and “about” are defined to mean +/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. A weight tracking system adapted to be installed on a toilet having a toilet seat and a toilet bowl, to measure a weight of a user, the weight tracking system comprising:
a first weight sensor adapted to be positioned between the toilet seat and the toilet bowl of a toilet, for determining a first weight measurement when the user sits upon the toilet seat;
a foot scale adapted to be positioned in front of the toilet bowl, the foot scale having a second weight sensor for determining a second weight measurement when the user sits upon the toilet seat;
a computer system having a computer processor and computer memory, the computer memory storing a weight analysis system in the form of computer code that, when executed by the computer processor, enables the computer system to perform a process that comprises the following steps:
collecting weight measurements of the user via the first and second weight sensors; and
determining the weight of the user by summing the first and second weight measurements.

2. The weight tracking system of claim 1, further comprising a digital display for displaying the weight of the user.

3. The weight tracking system of claim 1, further comprising a computer having a computer processor and a computer memory, the computer functioning to perform the following steps:
upon determining the weight of the user, determining the identity of the user; storing the weight measurement associated with the identity of the user.

4. The weight tracking system of claim 1, wherein the computer system further includes a wireless transmittal device adapted to enable wireless connectivity.

5. The weight tracking device of claim 1, wherein the first weight sensor includes a first load cell having a first plurality of strain sensors.

6. The weight tracking device of claim 1, wherein the second weight sensor includes a second load cell that includes a second plurality of strain sensors.

7. A weight tracking system adapted to be installed on a toilet, the weight tracking system comprising:
a toilet seat mounted on a toilet bowl of the toilet, the toilet seat having a first weight sensor and a first plurality of strain sensors for determining a first weight measurement when a user sits upon the toilet seat;
a foot scale positioned in front of the toilet bowl, the foot scale having a second weight sensor and a second plurality of strain sensors for determining a second weight measurement when the user sits upon the toilet seat;
a digital display for displaying the combined first and second weight measurements;
at least one battery for powering the toilet apparatus;
a computer system having a computer processor and computer memory, the computer memory storing a weight analysis system in the form of computer code that, when executed by the computer processor, enables the computer system to perform a process that comprises the following steps:
collecting weight measurements of the user via the weight sensors and pluralities of strain sensors; and
analyzing the weight measurements using the weight analysis system to determine weight changes over time.

8. The weight tracking system of claim 7, wherein the first plurality of strain sensors includes at least one strain gauge sensor on the bottom side of the toilet seat.

9. The weight tracking system of claim 7, wherein the weight tracking system is waterproof.

10. The weight tracking system of claim 7, wherein the computer system further includes a wireless transmittal device adapted to enable wireless connectivity.

11. A method for tracking a weight of a user, the method comprising the steps of:
providing a weight tracking system comprising a first weight sensor, a foot scale that includes a second weight sensor;
positioning the first weight sensor between the toilet seat and the toilet bowl of a toilet;
positioning the foot scale in front of the toilet bowl;
collecting weight measurements of the user when the user sits upon the toilet via the first and second weight sensors; and
determining the weight of the user by summing the first and second weight measurements.

12. The method of claim 11, further comprising the steps of: mounting a digital display on the toilet; and displaying the weight of the user upon the display.

13. The method of claim 11, further comprising the steps of identifying a user based upon previously measured weights; and storing weight measurements over time, associated with the user.
